(19) United States
(12) Patent Application Publication
(10) Pub. No.: US 2024/0061817 A1
(43) Pub. Date: Feb. 22, 2024

(54) DECLARATIVE DATABASE VIRTUALIZATION FOR FEDERATED APPLICATION PROGRAMMING INTERFACE

(71) Applicant: Salesforce, inc., San Francisco, CA (US)

(72) Inventors: Gaurav Sagar, Bellevue, WA (US); Gonzalo Guglielmo, Buenos Aires (AR); Antonio Garrote, San Francisco, CA (US); Patricio Barletta, Brentwood, CA (US); Luis Contreras, Buenos Aires (AR); Javier Isoldi, Buenos Aires (AR)

(21) Appl. No.: 17/821,393

(22) Filed: Aug. 22, 2022

(51) Int. Cl. G06F 16/21; G06F 16/25; G06F 16/2453

(52) U.S. Cl. CPC G06F 16/211; G06F 16/256; G06F 16/24544

(57) ABSTRACT

A federation management service may receive an indication of multiple data sources to integrate into a federated application programming interface (API). One of the data sources is a database that is associated with an API schema that includes annotations that map elements of the API schema to the features of the database. The federation management services processes the API schema to generate the federated API. The federated API may receive a request for an element that is mapped to the feature of the database, generate a query based on the annotations of the API schema, and return a result based on the generated query.

### FIELD OF TECHNOLOGY

The present disclosure relates generally to data processing, and more specifically to declarative database virtualization for federated application programming interface.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant data processing system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Clients or applications may interact with computing services via application programming interfaces (APIs). In some examples, an application may access different types of services (e.g., database service, web-service) using different endpoints. However, configuration of an application to access different APIs may require significant overhead and may result in application inefficiencies. More particularly, a developer may need to configure an application to access multiple APIs with different authentication settings, among other settings. Additionally, as an application may need to ping different APIs to perform a service, the application may have built-in latencies due to an operation depending on responses from multiple APIs, which may have different response times.

### BRIEF DESCRIPTION OF THE DRAWINGS

FIG. 1 illustrates an example of a data processing system that supports declarative database virtualization for federated application programming interface in accordance with aspects of the present disclosure.

FIG. 2 illustrates an example of a computing environment that supports declarative database virtualization for federated application programming interface in accordance with aspects of the present disclosure.

FIG. 3 illustrates an example of a computing system that supports declarative database virtualization for federated application programming interface in accordance with aspects of the present disclosure.

FIG. 4 illustrates an example of a process flow that supports declarative database virtualization for federated application programming interface in accordance with aspects of the present disclosure.

FIG. 5 shows a block diagram of an apparatus that supports declarative database virtualization for federated application programming interface in accordance with aspects of the present disclosure.

FIG. 6 shows a block diagram of an API manager that supports declarative database virtualization for federated application programming interface in accordance with aspects of the present disclosure.

FIG. 7 shows a diagram of a system including a device that supports declarative database virtualization for federated application programming interface in accordance with aspects of the present disclosure.

FIGS. 8 through 11 show flowcharts illustrating methods that support declarative database virtualization for federated application programming interface in accordance with aspects of the present disclosure.

### DETAILED DESCRIPTION

Clients or applications may interact with computing services via application programming interfaces (APIs). In some examples, an application may access different types of services (e.g., a web-service) using different APIs. However, configuration of an application to access different APIs may require significant overhead and may result in application inefficiencies. More particularly, a developer may need to configure an application to access multiple APIs with different authentication settings, among other settings. Additionally, as an application may need to ping different APIs to perform a service, the application may have built-in latencies due to an operation depending on a response from multiple APIs, which may have different response times.

Users of these various APIs may federate these APIs into a single federated API such as to simplify application configuration. An API federation service may generate a federated API that aggregates multiple data sources (e.g., APIs, databases, etc.), such that downstream consumers of the federated API can make a single query to retrieve data from the multiple data sources. In some examples, integration of a database into an API may require a dedicated service that handles API requests that correspond to a database, which may result in increased computing resource (e.g., processor) overhead. Additionally, databases, unlike APIs, when queried do not have a fixed or constant “shape” of the returned data. Databases may be accessed via various types of queries that result in different schema (e.g., a different data format) based on the type of query, and therefore, the returned data may be formatted differently for each query. As such, fitting a database into a federated API schema may be complex or difficult, as the shape or format of the data is inconsistent relative to the fixed nature of the format of typical API data.

Techniques described herein support integration of a database into a federated API. An API schema includes annotations that encode queries and features of the database queries to elements of the API schema. The annotations may declaratively link database tables and columns from a database to the API schema of the database. For example, a user may provide an input API schema (e.g., a partial or fragmented API schema) that includes declarative annotations that maps the features (e.g., fields, columns, tables) of the database to elements of the API schema (e.g., types, objects, fields). The API schema that includes the annotations may be processed by a federation management service to generate a federated API that maintains mappings of elements accessible via the federated API to the features of the database. As a result, the API may transform API calls to database queries. As such, an application may access elements of the federated API that includes API elements (e.g., types, fields, operations) of a data source API as well as API elements that are mapped to database queries for accessing data of the database, as described herein. As such, the application may access a data source API and the database using API calls to a same federated API.

As described in further detail herein, when generating a unified API schema (e.g., a schema of the federated API) based on multiple data sources, the federation management service may process the data access annotations in the API schema for the database and generate a target query in a database declarative language that will be used to fetch the data in the runtime. For example, this information may be stored, associated with the fields for the source, in a configuration metadata that is sent to a federation gateway together with any database credentials required to access the database. These credentials may be configured and managed in the same way as for other credentials for other data source APIs. Therefore, the federated schema may support one or more types of declarative query language without requiring a dedicated service and network API wrapping the data source to directly integrate the database into the federated schema.

Aspects of the disclosure are initially described in the context of an environment supporting an on-demand database service. Aspects of the disclosure are further described with respect to a computing environment illustrating federated API generation, computing environment that supports federated API generation based on database as a data source, and a process flow diagram. Aspects of the disclosure are further illustrated by and described with reference to apparatus diagrams, system diagrams, and flowcharts that relate to declarative database virtualization for federated application programming interface.

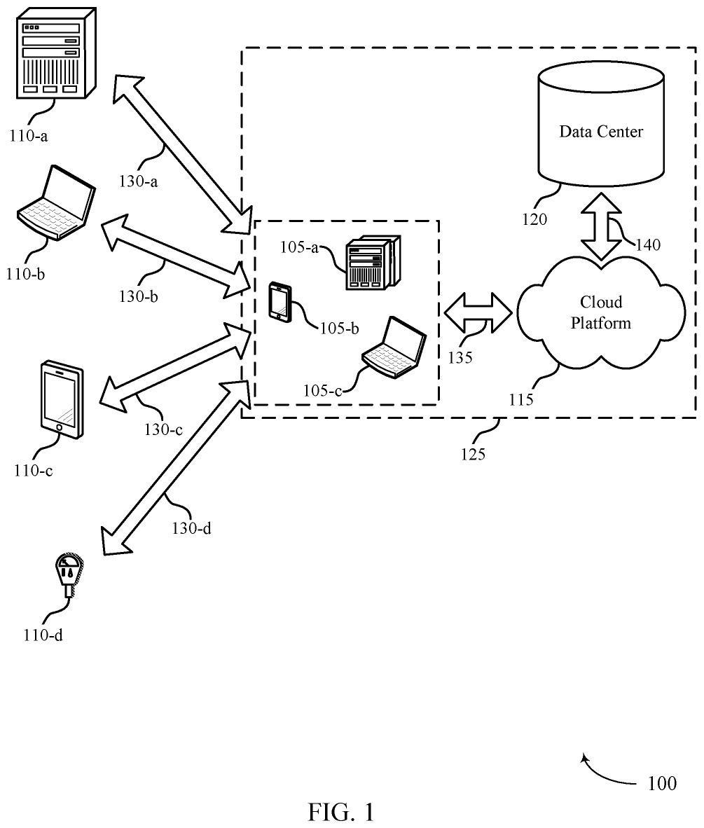

FIG. 1 illustrates an example of a system 100 for cloud computing that supports declarative database virtualization for federated application programming interface in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

In some examples, software applications may interface with data sources through one or more APIs. An API federation service may support creation of an aggregated or federated API from multiple APIs. In such examples, a user (e.g., an API architect or administrator) may declaratively link objects or fields from multiple APIs via a user interface. The API federation service may then generate a new API (e.g., a federated API) having a unified schema that incorporates the linkings across the multiple APIs. The federated API may be referred to as a datagraph.

In aspects of the present disclosure, the user may wish to integrate a database into a federated API. Databases, unlike APIs, when queried do not have a fixed or constant “shape” of the return data. Databases may be accessed via multiple schemas where queries may generate different schema (e.g., a different data format) based on the type of query, and therefore, the returned data may be formatted differently for each query. As such, fitting a database to a federated API schema may be complex or difficult, as the shape or format of the data is inconsistent relative to the fixed nature of the format of typical API data.

In some implementations of the present disclosure, to support fitting a query of the database (e.g., the data center 120) into the federated API, which may be implemented in the cloud platform 115, the query may be encoded into the federated API. The encoding may declaratively link database tables and columns from the database to elements that are imported into the federated API. For example, a user may provide an API schema that includes the declarative annotations that map the schema fields to tables and columns in the target database schema. However, the API schema may not function as a completed API on its own and may be used in connection with one of the API sources. As such, the declarative annotations may map the data fetched from the database to the federated API in a declarative way making it possible to process the API schema in a transparent way while hiding the details of the actual database providing the data.

In some other implementations, as part of the generation of the federated schema, a federation service (e.g., a federation management service) may also process data access annotations in the database source and generate a target query in a database declarative language that will be used to fetch the data in the runtime. For example, this information may be stored, associated with the fields for the source, in a configuration metadata that is sent to a federation gateway together with any database credentials relied on to access the database. These credentials may be configured and managed in the same way as for other credentials for other source APIs. Therefore, the federated API may support some type of declarative query language without requiring a dedicated service and a network API wrapping the data source to directly integrate the database into the federated schema.

It should be appreciated by a person skilled in the art that one or more aspects of the disclosure may be implemented in a system 100 to additionally or alternatively solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

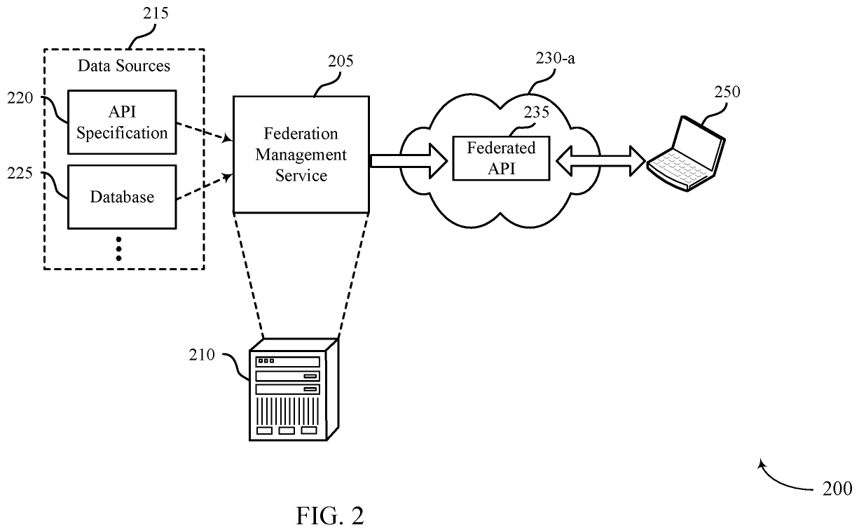

FIG. 2 illustrates an example of a computing environment 200 that supports declarative database virtualization for federated application programming interface in accordance with aspects of the present disclosure. The computing environment 200 includes a server 210, hosts 230, and client devices 250. The server 210 may be an example of aspects of cloud platform 115 of FIG. 1 and/or subsystem 125 of FIG. 1. The server 210 may represent various physical and/or logical computing systems that support a federation management service 205 that may be used by clients or tenants (e.g., cloud client 105 of FIG. 1) in support of applications that are accessible via computing devices, such as client devices 250.

Some applications (e.g., client applications executing on client devices 250, web services, etc.) may retrieve data from multiple data sources, such as data sources 215. For example, an application (or service supported by an application) may provide a status of an online purchase order, and the application may retrieve data related to shipping information from a first data source, data related to order status information from a second data source, and data related to the item being purchased from a third data source. The application may interface with these data sources using respective APIs. The data sources may include RESTful APIs, Async APIs, gRPC APIs, databases or the like. Conventional techniques for retrieving data or accessing services may require configuration of multiple APIs at the application and configuration of the application to process the data received from the multiple APIs (e.g., by merging or linking fields via hardcoded relationships).

The federation management service 205 described herein may support the creation of an aggregated or federated API 235 based on multiple data sources 215. In such examples, a user (e.g., an API architect or administrator) may declaratively link elements from multiple APIs using a user interface. The federation management service 205 may generate a new API having a unified schema that incorporates the linked elements across the multiple data sources 215. In some examples, the federated API may be referred to as a datagraph.

The federation management service 205 may support a user interface (UI) that allows a user to select multiple data sources 215 that are to be included in the federated API 235. The user may also select various deployment configurations, such as a host environment (e.g., a host 230-a, which may be an example of a cloud environment), endpoint details, authentication details, and the like. After selection of configuration parameters, the federation management service 205 may ingest or process the data sources 215, such as APIs and databases based on API specification 220 and/or a schema of a database 225, to generate the federated API 235. The federated API 235 may be deployed at the host environment (e.g., host 230-a) based on the user selected parameters. In some examples, the federated API 235 is deployed in a cloud environment (e.g., host 230-a). Additionally, or alternatively, the federated API 235 may be deployed at a local host (e.g., at a host associated with or supported by the server 210) or a host associated with the tenant or cloud client.

An application or client (e.g., an application or client executing on client devices 250) may be configured to access an endpoint of the federated API 235 to access data and/or services supported by the underlying data sources 215. As such, rather than accessing the data/services from multiple data source endpoints for each for the data sources 215, the application is configured to access the data/services using the endpoint(s) for the federated API 235, which may support improved computing efficiency (e.g., at the application and the hosts) and reduced complexity.

Additionally, The lifecycle and versioning of federated API 235 may be automatically managed by the federation management service 205. For example, one of the data sources 215 is updated, and the federation management service 205 automatically creates a new version of the federated API 235. Updates to the data sources 215 may include addition, deletion, or modification of a tag, updating the specification, etc.

Techniques described herein may support integration of a database 225 as a data source 215 to the federated API 235. The techniques include providing a API schema that includes declarative annotations that map elements of the API schema to features of the database 225. The API schema is processed by the federation management service 205, in conjunction with another data source 215, such as API specification 220, to generate the federated API 235 that includes elements that map to the various data sources 215 including the database 225. As such, a dedicated service and network API wrapping the data source may not be needed to integrate the database system into the federated API 235.

The federation management service 205 may receive the API schema configured for the database 225 as a data source 215. The federation management service 205 may process the API schema and the other data sources 215 to generate the federated API 235. In some cases, the API schema may include annotations that include a query for the database 225. The annotations of the API schema map the tables of the database 225 to API types (e.g., objects) and the columns of the tables of the database to API fields of the given API type (e.g., where the type is equivalent to the corresponding table). As such, the API schema may be input into the federation management service 205 as a data source 215 (e.g., a data source API specification). In some examples, the API schema may not function as an API outside of the federated API 235.

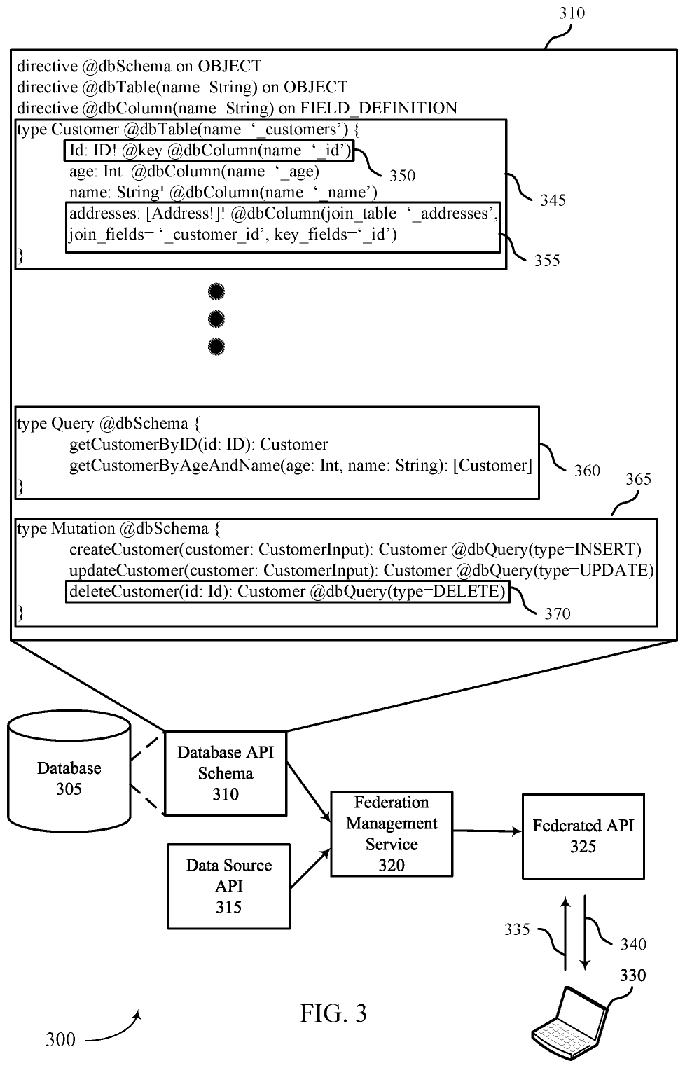

FIG. 3 illustrates an example of a computing system 300 that supports declarative database virtualization for federated application programming interface in accordance with aspects of the present disclosure. In some examples, the computing system 300 may implement aspects of the system 100 or computing environment 200. For example, the computing system 300 may include a database 305, a database API schema 310, a plurality of data source APIs 315, a federation management service 320, a federated API 325, and a client device 330, which may be examples of the corresponding devices and systems described with respect to FIGS. 1 and 2.

In some examples, the database 305 may be a data source input for the federation management service 320. However, as the format of a schema of a database query and query results may not be constant and fixed like the format of a schema (e.g., API specification) and API results of a data source API 315, a database API schema 310 may be configured to provide fixed format for database access and results. In some examples, the database API schema 310 may not act as an individual API outside of the use of the federation management service, and as such, the database API schema 310 may be referred to a partial or fragmented API schema as the database API schema 310. In some other cases, the database API schema 310 may be considered a data source of the federated API 325.

In some cases, the federation management service 320 may generate a federated API using (e.g., by processing) one or more data source APIs 315 and the database API schema 310. In some implementations, the federation management service 320 may receive the database API schema 310 as a special type of data source and may unify the database API schema with the data source APIs.

The federation management service 320 may also support the processing of data access annotations included in the database API schema 310 corresponding to the database 305 source. For example, the data access annotations may support the federation management service 320 in the generation of a target query in a database declarative language to fetch the data at runtime. In some cases, the data fetched may be stored, associated with the fields for the source, in a configuration metadata to be transmitted to a federation gateway along with a set of database credentials to access the database 305. The set of database credentials may be configured in a similar way as a set of credentials for a regular data source API 315 of the plurality of data source APIs. During the runtime of the federated gateway, the connectivity logic (e.g., the data access annotations) for the different supported databases 305 and the provided configurations (e.g., the set of credentials and the database 305 query) may be included to extract the requested data from the upstream database. The extracted data may be merged in a query result following similar orchestration logic used to merge information from regular data source APIs 315 of the plurality of data source APIs.

In some examples, the user may cause the client device 330 to submit an API request 335 to the federated API 325. In some cases, the API request 335 may include the client device 330 calling an API endpoint of the federated API 325. The federated API 325 may process the API request 335 and return a response 340 (e.g., data) to the client device 330. In some cases, the returned response 340 may be associated with data from one of the data sources of the federation management service, such as data source API 315 and/or the database 305. In some examples, the returned response 340 may include data associated with both the data source API 315 and the database API schema 310.

In accordance with examples as disclosed herein, the database API schema 310 may be defined as a partial or fragmented API schema. The database API schema 310 may include annotations that map tables of the database 305 and the columns of the tables to a data source API type (e.g., object) and the fields of the data type, respectively. In some examples, a data type (e.g., a type Customer 345) may be associated with a table of the database 305 named “_customers” via annotations. The name of the table of the database 305 may be an optional argument for the data type. In some cases, if no name is provided, the data type name (e.g., “Customer”) may be used as the table name as a default configurations. In some other examples, a field (e.g., a field “id”) of the data type Customer 345 may be associated with a column of the database 305 via annotation 350. For example, the field “id” is mapped to a column name “_id” of the table “_customers” of the database 305 via the annotation 350. In some other examples, as the column name is an optional argument for the field definition, the name of the field may be used as the column name. For example, if a field of the data type Customer 345 is named ‘age’ and there is a column in the customers table of the database 305 named “age,” the annotation (e.g., argument) may not be necessary as the federation management service 320 may make the connection between the field and the column of the database 305 for the user using a default configuration or rule that the parameter name is to be used for the feature name of the database 305.

In some examples, an annotation of the database API schema 310 may include parameters that map two (or more) database tables and/or two (or more) fields of a database table to an element of the database API schema 310. For example, the definition of the “addresses” field of the type Customer in annotation 355 includes a “join_fields” command that joins an multiple fields (e.g., columns) of the “_addresses” table of the database 305. The definition for the “addresses” fields also includes a “join_table” parameter that is mapped to an “addresses” table. The “join_table” parameter (e.g., argument or annotation) may synthesize the “addresses” field of the customer object by supporting execution of a join command of multiple fields of another table, following a 1 to n mapping. The “join_fields” argument may include a list of comma separated column names that represent a right part join referencing columns in the “join_table.” Additionally, a “key_fields” argument may also be included and set to “_id” referring to the “id” column of the customers table of the database 305. The “key_fields” argument may include a list of comma separated column names that represent the left part join.

In addition, a data type Query 360 and a data type Mutation 365 may be defined in the database API schema 310. The defined data type Query 360 and data type Mutation 365 are defined (by the annotations) to map API operations to a query for the database 305. For example, the data type Query 360 and data type Mutation 365 may function as marker annotations to indicate the database API schema 310 does not have an implementation. As such, the federation management service 320 may process the database API schema 310 as a database data source instead of a regular data source API 315 of the plurality of data source APIs.

A database query may be defined associated with a data type. For example, the database query may be associated with the data type Customer 345. In some examples, the database query arguments may include a SQL query. In some cases, the results of the SQL query may be used to populate sub-fields of the annotated field. Additionally, the database query arguments may also include a type (e.g., enum) that specifies a database operation type (e.g., DELETE, UPDATE, INSERT, or the like. For example, the database query may be associated with a delete operation (e.g., deleteCustomer operation 370) and may delete a customer based at least on a given id. In some cases, the query arguments may be useful when complex queries may be performed or when database 305 table column names and the database API schema 310 type fields do not match. In some other cases, the database query arguments may not be included and a query may be created by at runtime matching the argument parameters to where clauses (e.g., a clause used to filter data and return or extract the data that satisfies the clause) and selecting the table based at least on the return type of the query.

As described herein, the federation management service 320 may process the various annotations in a database API schema (e.g., the database API schema 310), in conjunction with other APIs, to generate the federated API 325. The resulting federated API 325 may maintain mappings of the elements of the federated API 325 to features of the database such that database queries may be executed at run-time. Thus, a client (e.g., client device 330) may access features of the underlying data source APIs 315 and the database 305 using the endpoint for the federated API 325.

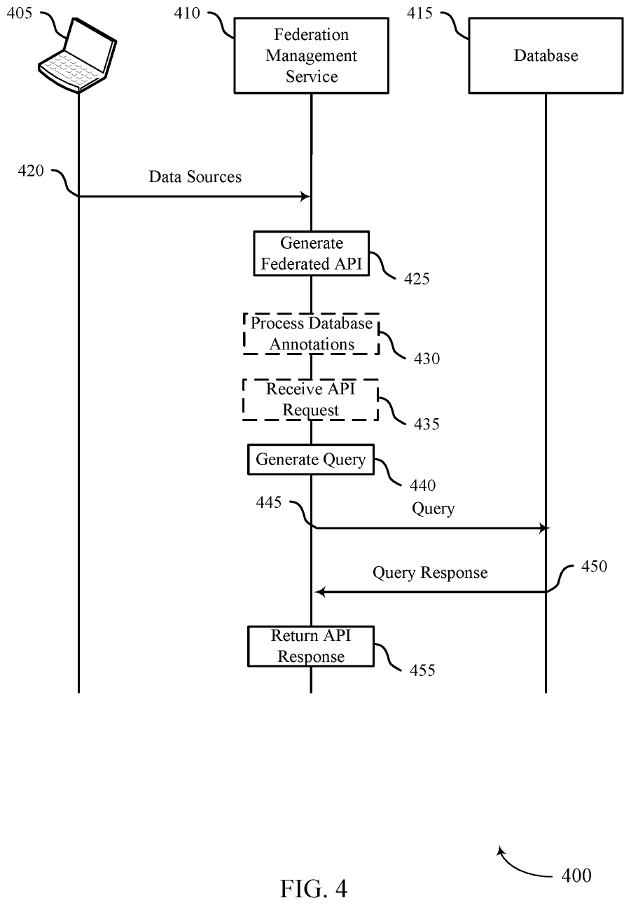

FIG. 4 illustrates an example of a process flow 400 that supports declarative database virtualization for federated application programming interface in accordance with aspects of the present disclosure. The process flow 400 includes a user device 405, a federation management service 410, and a database 415, which may be an example of the corresponding systems and devices as described with respect to FIGS. 1 through 3. In some examples, some signaling or procedure of the process flow 400 may occur in different orders than shown. Additionally, or alternatively, some additional procedures of signaling may occur, or some signaling or procedures may not occur.

At 420, the federation management service 410 may receive from a user device 405, a user input indicating a plurality of data sources as inputs into a federated API. At least one data source of the plurality of data sources may be the database 415 that may be associated with an API schema. The API schema may include annotations that map one or more elements of the API schema to features of the database 415 (e.g., database 415 tables and corresponding columns). In some examples, receiving the user input may include reviving the user input that indicates the API schema that includes the annotations. In some examples, the annotations may include an annotation that maps an element of the one or more elements to a first table and a second table of the database 415. In some cases, the annotation may include a join command that specifies the first table and the second table. For example, the annotations may include a first annotation that maps a type to a table of the database 415 and a second annotation that maps a field of the type to a column of the table of the database 415.

At 425, the federation management service 410 may generate the federated API from the plurality of data sources. The federated API may include one or more elements of the API schema. In some cases, generating the federated API may include generating the federated API that may include one or more API elements from a data source API of the plurality of data sources and an element of the one or more elements of the API schema that may be mapped to a database query for the database. In some examples, generating the federated API may be based at least on receiving the user input at 420 from the user device 405.

In some cases, the federation management service 410 may determine an absence of an annotation for the element of the API schema that maps the element to a feature of the database 415. Based at least in part on determining the absence of an annotation, the federation management service 410 may generate the federated API. The federated API may include a mapping of the element to a table with a table came corresponding to an element name of the element (e.g., based on a default mapping rule).

At 430, in some cases generating the federated API may include processing the annotations to generate at least one target query corresponding to an element of the API schema. The at least one query may be included in a federated API schema of the federated API. In some examples, the federation management service 410 may transmit, to an API gateway, an indication of the federated API schema that includes the at least one target query.

At 435, the federated API of the federation management service 410 may receive an API request (e.g., from a client or user device) corresponding to an element of the one or more elements. The request may indicate one of the elements this is mapped to a feature of the database 415.

At 440, the federated API of the federation management service 410 may generate, based at least in part on the annotations included in the API schema, a query for at least one feature (e.g., table, column, row) of the database.

At 445, the federated API of the federation management service 410 transmit the query to the database 415. At 450, the federated API of the federation management service 410 may receive a query response to the transmitted query.

At 455, the federated API of the federation management service 410 may return, in response to the API request at 435, a response that includes the feature of the database received in the query response.

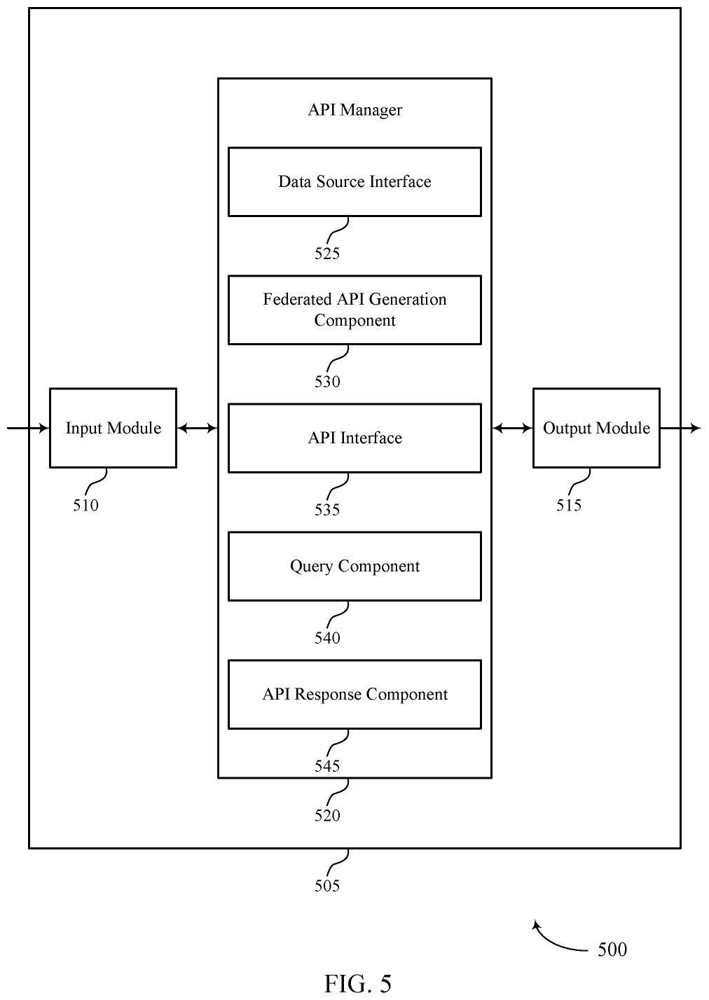

FIG. 5 shows a block diagram 500 of a device 505 that supports declarative database virtualization for federated application programming interface in accordance with aspects of the present disclosure. The device 505 may include an input module 510, an output module 515, and an API manager 520. The device 505 may also include a processor. Each of these components may be in communication with one another (e.g., via one or more buses).

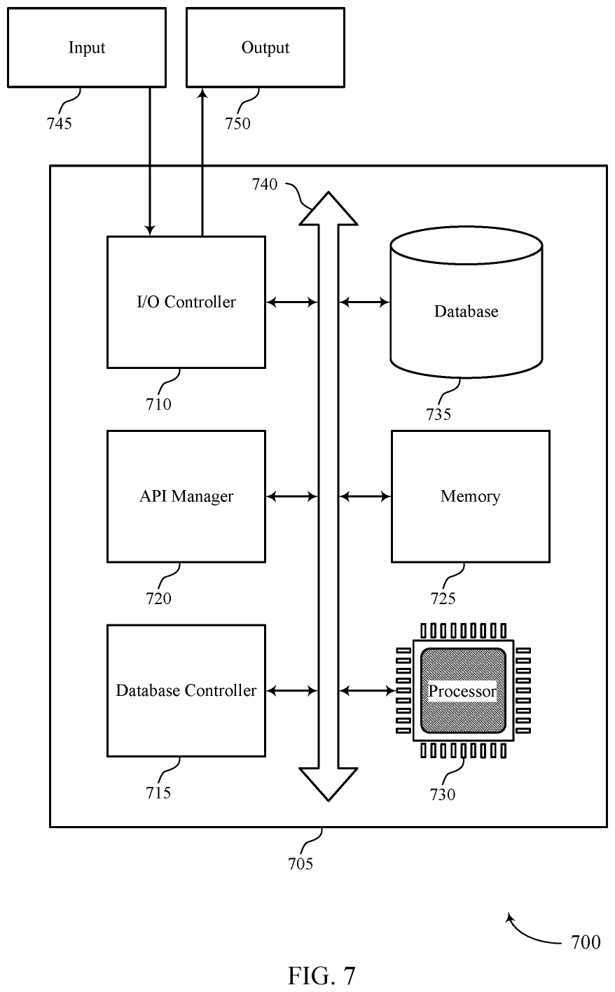

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the API manager 520 to support declarative database virtualization for federated application programming interface. In some cases, the input module 510 may be a component of an I/O controller 710 as described with reference to FIG. 7.

The output module 515 may manage output signals for the device 505. For example, the output module 515 may receive signals from other components of the device 505, such as the API manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the API manager 520 may include a data source interface 525, a federated API generation component 530, an API interface 535, a query component 540, an API response component 545, or any combination thereof. In some examples, the API manager 520, or various components thereof, may be configured to perform various operations (e.g., receiving, monitoring, transmitting) using or otherwise in cooperation with the input module 510, the output module 515, or both. For example, the API manager 520 may receive information from the input module 510, send information to the output module 515, or be integrated in combination with the input module 510, the output module 515, or both to receive information, transmit information, or perform various other operations as described herein.

The API manager 520 may support data processing in accordance with examples as disclosed herein. The data source interface 525 may be configured as or otherwise support a means for receiving, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database. The federated API generation component 530 may be configured as or otherwise support a means for generating the federated API from the set of multiple data sources, where the federated API includes the one or more elements of the API schema. The API interface 535 may be configured as or otherwise support a means for receiving, at the federated API, an API request corresponding to an element of the one or more elements. The query component 540 may be configured as or otherwise support a means for generating, based on the annotations included in the API schema, a query for a feature of the database. The API response component 545 may be configured as or otherwise support a means for returning, in response to the API request, a response that includes the feature of the database.

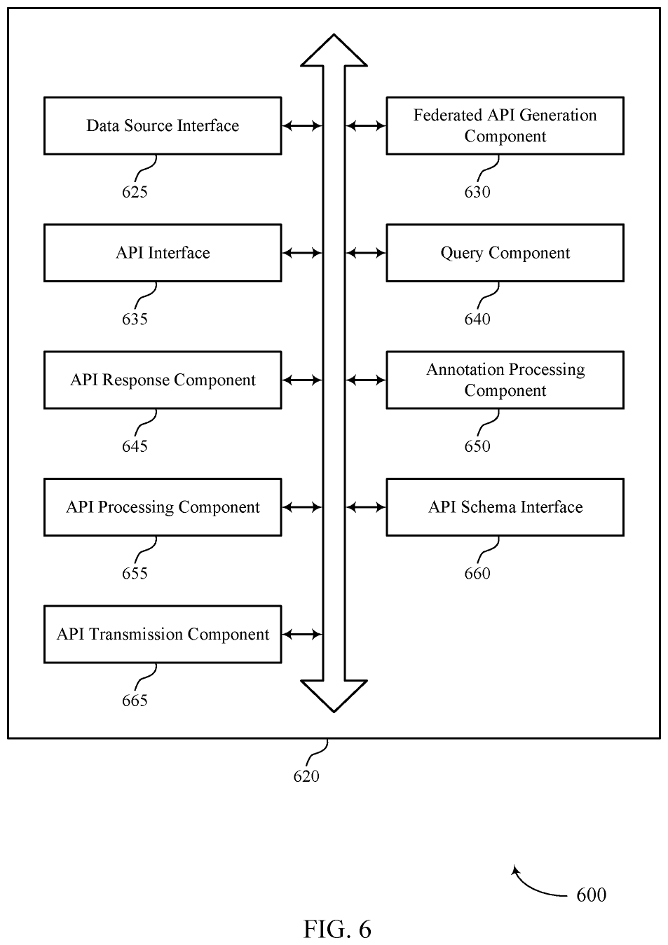

FIG. 6 shows a block diagram 600 of an API manager 620 that supports declarative database virtualization for federated application programming interface in accordance with aspects of the present disclosure. The API manager 620 may be an example of aspects of an API manager or an API manager 520, or both, as described herein. The API manager 620, or various components thereof, may be an example of means for performing various aspects of declarative database virtualization for federated application programming interface as described herein. For example, the API manager 620 may include a data source interface 625, a federated API generation component 630, an API interface 635, a query component 640, an API response component 645, an annotation processing component 650, an API processing component 655, an API schema interface 660, an API transmission component 665, or any combination thereof. Each of these components may communicate, directly or indirectly, with one another (e.g., via one or more buses).

The API manager 620 may support data processing in accordance with examples as disclosed herein. The data source interface 625 may be configured as or otherwise support a means for receiving, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database. The federated API generation component 630 may be configured as or otherwise support a means for generating the federated API from the set of multiple data sources, where the federated API includes the one or more elements of the API schema. The API interface 635 may be configured as or otherwise support a means for receiving, at the federated API, an API request corresponding to an element of the one or more elements. The query component 640 may be configured as or otherwise support a means for generating, based on the annotations included in the API schema, a query for a feature of the database. The API response component 645 may be configured as or otherwise support a means for returning, in response to the API request, a response that includes the feature of the database.

In some examples, to support generating the federated API, the federated API generation component 630 may be configured as or otherwise support a means for generating the federated API that includes one or more API elements from a data source API of the set of multiple data sources and an element of the one or more elements of the API schema that is mapped to a database query for the database.

In some examples, to support generating the federated API, the annotation processing component 650 may be configured as or otherwise support a means for processing the annotations to generate at least one target query corresponding to an element of the API schema, where the at least one target query is included in a federated API schema of the federated API.

In some examples, the API transmission component 665 may be configured as or otherwise support a means for transmitting, to an API gateway, an indication of the federated API schema that includes the at least one target query.

In some examples, the annotations include an annotation that maps an element of the one or more elements to a first table and a second table of the database.

In some examples, the annotation includes a join command that specifies the first table and the second table.

In some examples, the annotations include a first annotation that maps a type to a table of the database and a second annotation that maps a field of the type to a column of the table of the database.

In some examples, the API processing component 655 may be configured as or otherwise support a means for determining an absence of an annotation for the element of the API schema that maps the element to a feature of the database. In some examples, the federated API generation component 630 may be configured as or otherwise support a means for generating, based on determining the absence, the federated API that includes a mapping of the element to a table with a table name corresponding to an element name of the element.

In some examples, to support receiving the user input, the API schema interface 660 may be configured as or otherwise support a means for receiving the user input that indicates the API schema that includes the annotations, where the federated API is generated based on receiving the user input.

FIG. 7 shows a diagram of a system 700 including a device 705 that supports declarative database virtualization for federated application programming interface in accordance with aspects of the present disclosure. The device 705 may be an example of or include the components of a device 505 as described herein. The device 705 may include components for bi-directional data communications including components for transmitting and receiving communications, such as an API manager 720, an I/O controller 710, a database controller 715, a memory 725, a processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a BIOS which may control basic hardware or software operation such as the interaction with peripheral components or devices.

The processor 730 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting declarative database virtualization for federated application programming interface).

The API manager 720 may support data processing in accordance with examples as disclosed herein. For example, the API manager 720 may be configured as or otherwise support a means for receiving, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database. The API manager 720 may be configured as or otherwise support a means for generating the federated API from the set of multiple data sources, where the federated API includes the one or more elements of the API schema. The API manager 720 may be configured as or otherwise support a means for receiving, at the federated API, an API request corresponding to an element of the one or more elements. The API manager 720 may be configured as or otherwise support a means for generating, based on the annotations included in the API schema, a query for a feature of the database. The API manager 720 may be configured as or otherwise support a means for returning, in response to the API request, a response that includes the feature of the database.

By including or configuring the API manager 720 in accordance with examples as described herein, the device 705 may support techniques for integration of a database into a federated API, which may support efficient client access of API elements that correspond to data source APIs as well as the database. The described techniques support database integration without custom data wrapping.

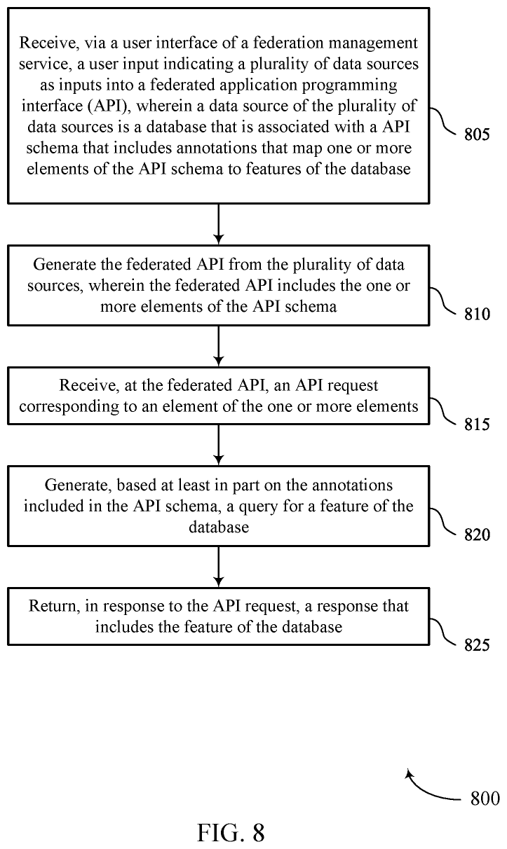

FIG. 8 shows a flowchart illustrating a method 800 that supports declarative database virtualization for federated application programming interface in accordance with aspects of the present disclosure. The operations of the method 800 may be implemented by a server or its components as described herein. For example, the operations of the method 800 may be performed by a server as described with reference to FIGS. 1 through 7. In some examples, a server may execute a set of instructions to control the functional elements of the server to perform the described functions. Additionally, or alternatively, the server may perform aspects of the described functions using special-purpose hardware.

At 805, the method may include receiving, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database. The operations of 805 may be performed in accordance with examples as disclosed herein. In some examples, aspects of the operations of 805 may be performed by a data source interface 625 as described with reference to FIG. 6.

At 810, the method may include generating the federated API from the set of multiple data sources, where the federated API includes the one or more elements of the API schema. The operations of 810 may be performed in accordance with examples as disclosed herein. In some examples, aspects of the operations of 810 may be performed by a federated API generation component 630 as described with reference to FIG. 6.

At 815, the method may include receiving, at the federated API, an API request corresponding to an element of the one or more elements. The operations of 815 may be performed in accordance with examples as disclosed herein. In some examples, aspects of the operations of 815 may be performed by an API interface 635 as described with reference to FIG. 6.

At 820, the method may include generating, based on the annotations included in the API schema, a query for a feature of the database. The operations of 820 may be performed in accordance with examples as disclosed herein. In some examples, aspects of the operations of 820 may be performed by a query component 640 as described with reference to FIG. 6.

At 825, the method may include returning, in response to the API request, a response that includes the feature of the database. The operations of 825 may be performed in accordance with examples as disclosed herein. In some examples, aspects of the operations of 825 may be performed by an API response component 645 as described with reference to FIG. 6.

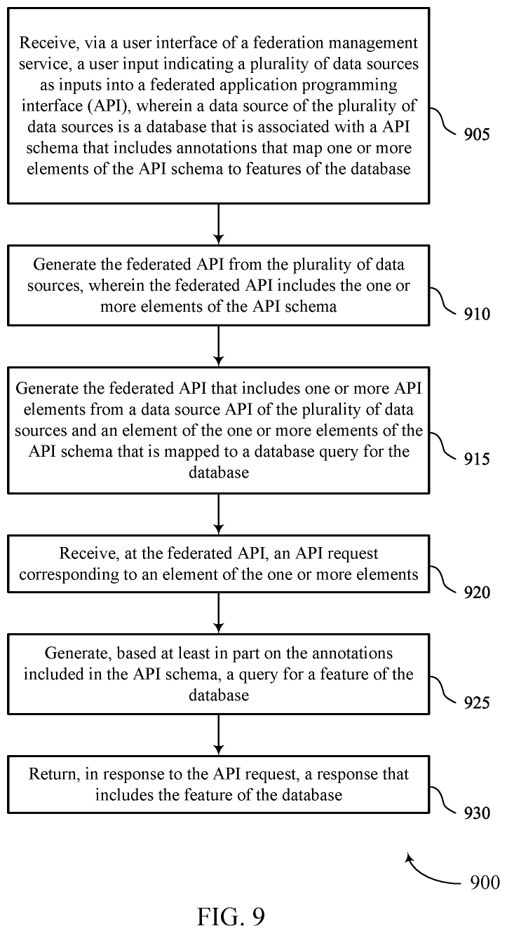

FIG. 9 shows a flowchart illustrating a method 900 that supports declarative database virtualization for federated application programming interface in accordance with aspects of the present disclosure. The operations of the method 900 may be implemented by a server or its components as described herein. For example, the operations of the method 900 may be performed by a server as described with reference to FIGS. 1 through 7. In some examples, a server may execute a set of instructions to control the functional elements of the server to perform the described functions. Additionally, or alternatively, the server may perform aspects of the described functions using special-purpose hardware.

At 905, the method may include receiving, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database. The operations of 905 may be performed in accordance with examples as disclosed herein. In some examples, aspects of the operations of 905 may be performed by a data source interface 625 as described with reference to FIG. 6.

At 910, the method may include generating the federated API from the set of multiple data sources, where the federated API includes the one or more elements of the API schema. The operations of 910 may be performed in accordance with examples as disclosed herein. In some examples, aspects of the operations of 910 may be performed by a federated API generation component 630 as described with reference to FIG. 6.

At 915, the method may include generating the federated API that includes one or more API elements from a data source API of the set of multiple data sources and an element of the one or more elements of the API schema that is mapped to a database query for the database. The operations of 915 may be performed in accordance with examples as disclosed herein. In some examples, aspects of the operations of 915 may be performed by a federated API generation component 630 as described with reference to FIG. 6.

At 920, the method may include receiving, at the federated API, an API request corresponding to an element of the one or more elements. The operations of 920 may be performed in accordance with examples as disclosed herein. In some examples, aspects of the operations of 920 may be performed by an API interface 635 as described with reference to FIG. 6.

At 925, the method may include generating, based on the annotations included in the API schema, a query for a feature of the database. The operations of 925 may be performed in accordance with examples as disclosed herein. In some examples, aspects of the operations of 925 may be performed by a query component 640 as described with reference to FIG. 6.

At 930, the method may include returning, in response to the API request, a response that includes the feature of the database. The operations of 930 may be performed in accordance with examples as disclosed herein. In some examples, aspects of the operations of 930 may be performed by an API response component 645 as described with reference to FIG. 6.

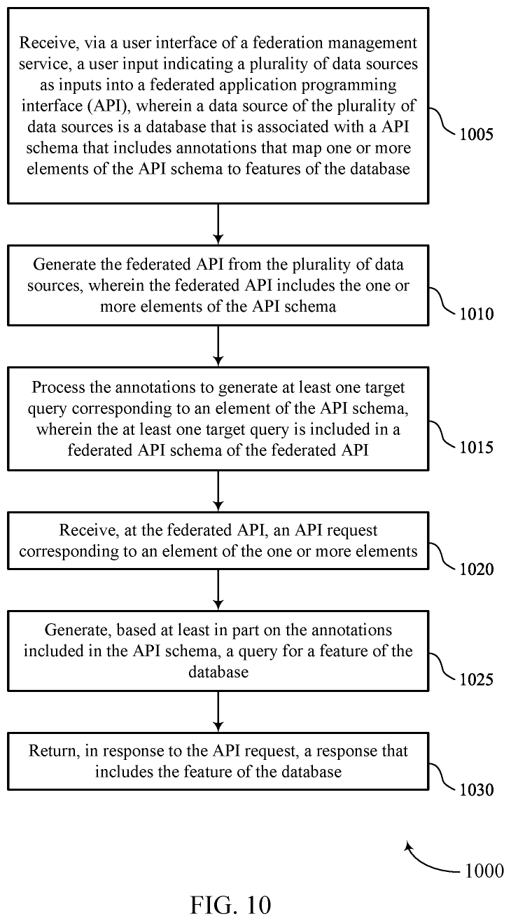

FIG. 10 shows a flowchart illustrating a method 1000 that supports declarative database virtualization for federated application programming interface in accordance with aspects of the present disclosure. The operations of the method 1000 may be implemented by a server or its components as described herein. For example, the operations of the method 1000 may be performed by a server as described with reference to FIGS. 1 through 7. In some examples, a server may execute a set of instructions to control the functional elements of the server to perform the described functions. Additionally, or alternatively, the server may perform aspects of the described functions using special-purpose hardware.

At 1005, the method may include receiving, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database. The operations of 1005 may be performed in accordance with examples as disclosed herein. In some examples, aspects of the operations of 1005 may be performed by a data source interface 625 as described with reference to FIG. 6.

At 1010, the method may include generating the federated API from the set of multiple data sources, where the federated API includes the one or more elements of the API schema. The operations of 1010 may be performed in accordance with examples as disclosed herein. In some examples, aspects of the operations of 1010 may be performed by a federated API generation component 630 as described with reference to FIG. 6.

At 1015, the method may include processing the annotations to generate at least one target query corresponding to an element of the API schema, where the at least one target query is included in a federated API schema of the federated API. The operations of 1015 may be performed in accordance with examples as disclosed herein. In some examples, aspects of the operations of 1015 may be performed by an annotation processing component 650 as described with reference to FIG. 6.

At 1020, the method may include receiving, at the federated API, an API request corresponding to an element of the one or more elements. The operations of 1020 may be performed in accordance with examples as disclosed herein. In some examples, aspects of the operations of 1020 may be performed by an API interface 635 as described with reference to FIG. 6.

At 1025, the method may include generating, based on the annotations included in the API schema, a query for a feature of the database. The operations of 1025 may be performed in accordance with examples as disclosed herein. In some examples, aspects of the operations of 1025 may be performed by a query component 640 as described with reference to FIG. 6.

At 1030, the method may include returning, in response to the API request, a response that includes the feature of the database. The operations of 1030 may be performed in accordance with examples as disclosed herein. In some examples, aspects of the operations of 1030 may be performed by an API response component 645 as described with reference to FIG. 6.

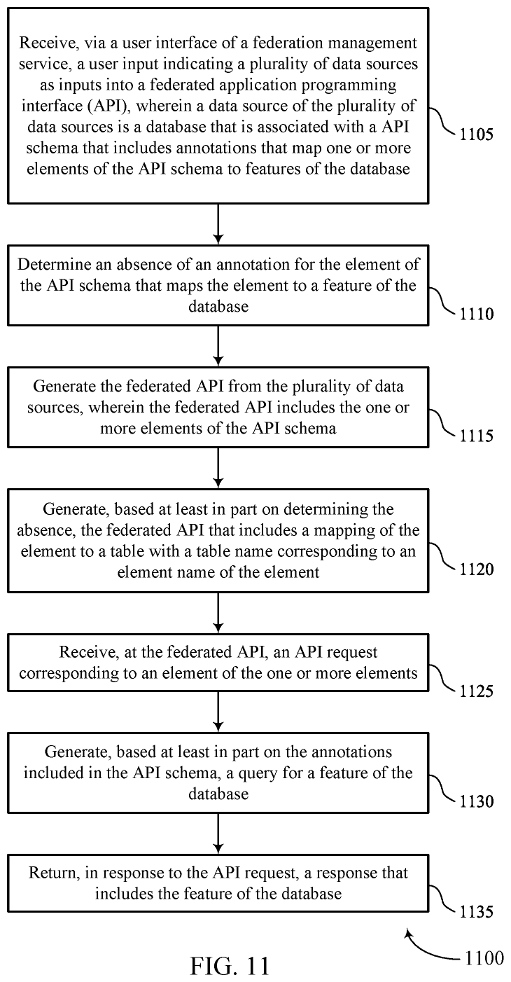

FIG. 11 shows a flowchart illustrating a method 1100 that supports declarative database virtualization for federated application programming interface in accordance with aspects of the present disclosure. The operations of the method 1100 may be implemented by a server or its components as described herein. For example, the operations of the method 1100 may be performed by a server as described with reference to FIGS. 1 through 7. In some examples, a server may execute a set of instructions to control the functional elements of the server to perform the described functions. Additionally, or alternatively, the server may perform aspects of the described functions using special-purpose hardware.

At 1105, the method may include receiving, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database. The operations of 1105 may be performed in accordance with examples as disclosed herein. In some examples, aspects of the operations of 1105 may be performed by a data source interface 625 as described with reference to FIG. 6.

At 1110, the method may include determining an absence of an annotation for the element of the API schema that maps the element to a feature of the database. The operations of 1110 may be performed in accordance with examples as disclosed herein. In some examples, aspects of the operations of 1110 may be performed by an API processing component 655 as described with reference to FIG. 6.

At 1115, the method may include generating the federated API from the set of multiple data sources, where the federated API includes the one or more elements of the API schema. The operations of 1115 may be performed in accordance with examples as disclosed herein. In some examples, aspects of the operations of 1115 may be performed by a federated API generation component 630 as described with reference to FIG. 6.

At 1120, the method may include generating, based on determining the absence, the federated API that includes a mapping of the element to a table with a table name corresponding to an element name of the element. The operations of 1120 may be performed in accordance with examples as disclosed herein. In some examples, aspects of the operations of 1120 may be performed by a federated API generation component 630 as described with reference to FIG. 6.

At 1125, the method may include receiving, at the federated API, an API request corresponding to an element of the one or more elements. The operations of 1125 may be performed in accordance with examples as disclosed herein. In some examples, aspects of the operations of 1125 may be performed by an API interface 635 as described with reference to FIG. 6.

At 1130, the method may include generating, based on the annotations included in the API schema, a query for a feature of the database. The operations of 1130 may be performed in accordance with examples as disclosed herein. In some examples, aspects of the operations of 1130 may be performed by a query component 640 as described with reference to FIG. 6.

At 1135, the method may include returning, in response to the API request, a response that includes the feature of the database. The operations of 1135 may be performed in accordance with examples as disclosed herein. In some examples, aspects of the operations of 1135 may be performed by an API response component 645 as described with reference to FIG. 6.

A method for data processing is described. The method may include receiving, via a user interface of a federation management service, a user input indicating a set of multiple data sources as inputs into a federated application programming interface (API), where a data source of the set of multiple data sources is a database that is associated with API schema that includes annotations that map one or more elements of the API schema to features of the database, generating the federated API from the set of multiple data sources, where the federated API includes the one or more elements of the API schema, receiving, at the federated API, an API request corresponding to an element of the one or more elements, generating, based on the annotations included in the API schema, a query for a feature of the database, and returning, in response to the API request, a response that includes the feature of the database.

An apparatus for data processing is described. The apparatus may include a processor, memory coupled with the processor, and instructions stored in the memory. The instructions may be executable by the processor to cause the apparatus to receive, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database, generate the federated API from the set of multiple data sources, where the federated API includes the one or more elements of the API schema, receive, at the federated API, an API request corresponding to an element of the one or more elements, generate, based on the annotations included in the API schema, a query for a feature of the database, and return, in response to the API request, a response that includes the feature of the database.

Another apparatus for data processing is described. The apparatus may include means for receiving, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database, means for generating the federated API from the set of multiple data sources, where the federated API includes the one or more elements of the API schema, means for receiving, at the federated API, an API request corresponding to an element of the one or more elements, means for generating, based on the annotations included in the API schema, a query for a feature of the database, and means for returning, in response to the API request, a response that includes the feature of the database.

A non-transitory computer-readable medium storing code for data processing is described. The code may include instructions executable by a processor to receive, via a user interface of a federation management service, a user input indicating a set of multiple data sources as inputs into a federated application programming interface (API), where a data source of the set of multiple data sources is a database that is associated with a API schema that includes annotations that map one or more elements of the API schema to features of the database, generate the federated API from the set of multiple data sources, where the federated API includes the one or more elements of the API schema, receive, at the federated API, an API request corresponding to an element of the one or more elements, generate, based on the annotations included in the API schema, a query for a feature of the database, and return, in response to the API request, a response that includes the feature of the database.

In some examples of the method, apparatuses, and non-transitory computer-readable medium described herein, generating the federated API may include operations, features, means, or instructions for generating the federated API that includes one or more API elements from a data source API of the set of multiple data sources and an element of the one or more elements of the API schema that may be mapped to a database query for the database.

In some examples of the method, apparatuses, and non-transitory computer-readable medium described herein, generating the federated API may include operations, features, means, or instructions for processing the annotations to generate at least one target query corresponding to an element of the API schema, where the at least one target query may be included in a federated API schema of the federated API.

Some examples of the method, apparatuses, and non-transitory computer-readable medium described herein may further include operations, features, means, or instructions for transmitting, to an API gateway, an indication of the federated API schema that includes the at least one target query.

In some examples of the method, apparatuses, and non-transitory computer-readable medium described herein, the annotations include an annotation that maps an element of the one or more elements to a first table and a second table of the database.

In some examples of the method, apparatuses, and non-transitory computer-readable medium described herein, the annotation includes a join command that specifies the first table and the second table.

In some examples of the method, apparatuses, and non-transitory computer-readable medium described herein, the annotations include a first annotation that maps a type to a table of the database and a second annotation that maps a field of the type to a column of the table of the database.

Some examples of the method, apparatuses, and non-transitory computer-readable medium described herein may further include operations, features, means, or instructions for determining an absence of an annotation for the element of the API schema that maps the element to a feature of the database and generating, based on determining the absence, the federated API that includes a mapping of the element to a table with a table name corresponding to an element name of the element.

In some examples of the method, apparatuses, and non-transitory computer-readable medium described herein, receiving the user input may include operations, features, means, or instructions for receiving the user input that indicates the API schema that includes the annotations, where the federated API may be generated based on receiving the user input.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for data processing, comprising:
receiving, via a user interface of a federation management service, a user input indicating a plurality of data sources as inputs into a federated application programming interface (API), wherein a data source of the plurality of data sources is a database that is associated with a API schema that includes annotations that map one or more elements of the API schema to features of the database;
generating the federated API from the plurality of data sources, wherein the federated API includes the one or more elements of the API schema;
receiving, at the federated API, an API request corresponding to an element of the one or more elements;
generating, based at least in part on the annotations included in the API schema, a query for a feature of the database; and
returning, in response to the API request, a response that includes the feature of the database.

2. The method of claim 1, wherein generating the federated API comprises:
generating the federated API that includes one or more API elements from a data source API of the plurality of data sources and an element of the one or more elements of the API schema that is mapped to a database query for the database.

3. The method of claim 1, wherein generating the federated API comprises:
processing the annotations to generate at least one target query corresponding to an element of the API schema, wherein the at least one target query is included in a federated API schema of the federated API.

4. The method of claim 3, further comprising:
transmitting, to an API gateway, an indication of the federated API schema that includes the at least one target query.

5. The method of claim 1, wherein the annotations include an annotation that maps an element of the one or more elements to a first table and a second table of the database.

6. The method of claim 5, wherein the annotation comprises a join command that specifies the first table and the second table.

7. The method of claim 1, wherein the annotations include a first annotation that maps a type to a table of the database and a second annotation that maps a field of the type to a column of the table of the database.

8. The method of claim 1, further comprising:
determining an absence of an annotation for the element of the API schema that maps the element to a feature of the database; and
generating, based at least in part on determining the absence, the federated API that includes a mapping of the element to a table with a table name corresponding to an element name of the element.

9. The method of claim 1, wherein receiving the user input comprises:
receiving the user input that indicates the API schema that includes the annotations, wherein the federated API is generated based at least in part on receiving the user input.

10. An apparatus for data processing, comprising:
a processor;
memory coupled with the processor; and
instructions stored in the memory and executable by the processor to cause the apparatus to:
receive, via a user interface of a federation management service, a user input indicating a plurality of data sources as inputs into a federated application programming interface (API), wherein a data source of the plurality of data sources is a database that is associated with a API schema that includes annotations that map one or more elements of the API schema to features of the database;
generate the federated API from the plurality of data sources, wherein the federated API includes the one or more elements of the API schema;
receive, at the federated API, an API request corresponding to an element of the one or more elements;
generate, based at least in part on the annotations included in the API schema, a query for a feature of the database; and
return, in response to the API request, a response that includes the feature of the database.

11. The apparatus of claim 10, wherein the instructions to generate the federated API are executable by the processor to cause the apparatus to:
generate the federated API that includes one or more API elements from a data source API of the plurality of data sources and an element of the one or more elements of the API schema that is mapped to a database query for the database.

12. The apparatus of claim 10, wherein the instructions to generate the federated API are executable by the processor to cause the apparatus to:
process the annotations to generate at least one target query corresponding to an element of the API schema, wherein the at least one target query is included in a federated API schema of the federated API.

13. The apparatus of claim 12, wherein the instructions are further executable by the processor to cause the apparatus to:
transmit, to an API gateway, an indication of the federated API schema that includes the at least one target query.

14. The apparatus of claim 10, wherein the annotations include an annotation that maps an element of the one or more elements to a first table and a second table of the database.

15. The apparatus of claim 14, wherein the annotation comprises a join command that specifies the first table and the second table.

16. A non-transitory computer-readable medium storing code for data processing, the code comprising instructions executable by a processor to:
receive, via a user interface of a federation management service, a user input indicating a plurality of data sources as inputs into a federated application programming interface (API), wherein a data source of the plurality of data sources is a database that is associated with a API schema that includes annotations that map one or more elements of the API schema to features of the database;
generate the federated API from the plurality of data sources, wherein the federated API includes the one or more elements of the API schema;
receive, at the federated API, an API request corresponding to an element of the one or more elements;
generate, based at least in part on the annotations included in the API schema, a query for a feature of the database; and
return, in response to the API request, a response that includes the feature of the database.

17. The non-transitory computer-readable medium of claim 16, wherein the instructions to generate the federated API are executable by the processor to:
generate the federated API that includes one or more API elements from a data source API of the plurality of data sources and an element of the one or more elements of the API schema that is mapped to a database query for the database.

18. The non-transitory computer-readable medium of claim 16, wherein the instructions to generate the federated API are executable by the processor to:
process the annotations to generate at least one target query corresponding to an element of the API schema, wherein the at least one target query is included in a federated API schema of the federated API.

19. The non-transitory computer-readable medium of claim 18, wherein the instructions are further executable by the processor to:
transmit, to an API gateway, an indication of the federated API schema that includes the at least one target query.

20. The non-transitory computer-readable medium of claim 16, wherein the annotations include an annotation that maps an element of the one or more elements to a first table and a second table of the database.
